(19) United States
(12) Patent Application Publication
(10) Pub. No.: US 2014/0138917 A1
(43) Pub. Date: May 22, 2014

(54) One Piece Oil Pan Gasket

(71) Applicant: Bill Sieff, North Haven, CT (US)

(72) Inventor: Bill Sieff, North Haven, CT (US)

(21) Appl. No.: 14/086,337

(22) Filed: Nov. 21, 2013

Related U.S. Application Data
(60) Provisional application No. 61/729,238, filed on Nov. 21, 2012.

(51) Int. Cl. F02F 11/00

(52) U.S. Cl. CPC F02F 11/00
USPC 277/313; 277/598

(57) ABSTRACT

Kits and methods of sealing an engine oil pan to its respective engine block by using a molded gasket of removable type that fits between the oil pan and engine block and timing cover. A removable gasket that fits between the oil pan and engine block and timing cover that does not require silicone sealant for fastening the oil pan to the engine block.

### FIELD OF THE INVENTION

The present invention relates to methods and kits for sealing an engine oil pan to its respective engine block.

### BACKGROUND OF THE INVENTION

The use of gaskets for use in sealing oil pans to engine blocks to prevent engine oil from leaking from the engine crankcase is not new. To apply the oil pan to the engine block, a gasket is used in conjunction with liquid silicone rubber to seal an engine block to a corresponding oil pan. The liquid silicone rubber cures, thus, sealing the engine block to the corresponding oil pan via the gasket.

The International T444E and the Ford Powerstroke Diesel engines are in the same family of engines. This family of engines was designed without the use of an oil pan gasket. The designers intended that the oil pan be sealed to the engine block only by using a liquid silicone rubber material that would cure after it was dispensed, creating a seal between the engine block and the oil pan.

This method of sealing works acceptably in new production when curing time is not an issue and when the automated method of dispensing creates a consistently uniform deposit of the liquid silicone. In new production, when the oil pan is installed and tightened, it is allowed to cure for hours before exposure to engine oil and operating temperatures of the engine. The consistent nature of the silicone deposit rate ensures that the proper amount and location of the silicone will result in a liquid and an air tight seal.

However, the International T444E and the Ford Powerstroke Diesel engines are difficult to service due to the adhesive nature of the silicone rubber sealing material, as the seal between the oil pan or the lower portion of the engine (crankshaft, connecting rods, main bearings, connecting rod bearings) must be broken in order to service these engines.

To service the the International T444E and the Ford Powerstroke Diesel engines, the oil pan must be pried off using substantial force to break the seal between the engine block and oil pan. This sometime requires hammering a chisel type device between the oil pan and engine block to create separation between the two engine components. Often, the oil pan may become damaged and/or deformed during the prying and chiseling process.

Once the oil pan is removed from the engine block, a laborious task is required to clean off the silicone rubber residue to provide a clean surface for a proper seal upon reinstallation. This cleaning task must be performed on the engine block, the timing cover, and the oil pan.

Additional disadvantages to using liquid silicone sealer to attach the oil pan to the engine block includes mechanics not applying the correct amount of silicone sealer when servicing the engine. When too little silicone sealer is applied, the seal between the engine block and oil pan is not formed correctly. If too much silicone sealer is applied to the engine block and oil pan, the curing time greatly increases to the point whereby it becomes inefficient and whereby delays persist.

Other disadvantages in the prior art include a mechanic often finding leaks once the sealer cures (typically 24 hours after applying the silicone sealer). In this situation, it often takes hours till a mechanic knows whether or not the sealing is done properly, and inevitable delays for servicing the engine occur due to this problem.

It is thus, desirable to provide a method of sealing an engine oil pan to its respective engine block and a gasket that overcome the aforementioned disadvantages in the prior art.

### SUMMARY OF THE INVENTION

Accordingly, it is the object of this present invention to provide a method of sealing the engine block, timing cover, and oil pan using a molded gasket between the engine block, timing cover, and oil pan in lieu of the liquid silicone rubber material.

It is another object to provide a gasket that eliminates the sole use of liquid silicone sealer to seal an oil pan to an engine block.

These objects are achieved by providing a method for sealing an oil pan to a engine block, the method comprising: providing a gasket; placing the gasket between an oil pan and an engine block; and sealing the gasket to the oil pan and the engine block, wherein the gasket is molded to fit between the oil pan and the engine block, and wherein the gasket is removable.

In certain embodiments, the oil pan is an International T444E engine oil pan or a Ford Powerstroke oil pan. In certain embodiments, the gasket is one-piece molded gasket. In certain embodiments, the gasket includes multiple parts and/or is made of multiple components. In certain embodiments, the gasket is made of one-piece.

In certain embodiments, the gasket includes bores and/or holes within the gasket. In certain embodiments, the bores are of multiple sizes.

In certain embodiments, the gasket includes load limiters that prevent over-tightening fasteners located on the oil pan. In certain embodiments, the load limiters are positioned within the bores in the gasket.

In certain embodiments, the gasket includes at least one fastening member. In certain embodiments, the gasket includes at least one tightening member. In certain embodiments, the at least one fastening member and the at least one tightening member are used to secure the gasket to the oil pan and engine block to seal the oil pan to the engine block. In certain embodiments, the at least one fastening member is a threaded bolt or a threaded screw. In certain embodiments, the at least one tightening member is

In certain embodiments, the gasket includes a rigid core, the rigid core being made of metal and/or plastic.

In certain embodiments, the gasket is reusable after it is removed. In certain embodiments, the gasket mates against the engine block and the oil pan, and seals surfaces without the need to use liquid silicone rubber. In certain embodiments, the gasket is sealed to the oil pan and the engine block without curing.

Other objects of the invention are achieved by providing a method for sealing an oil pan to an engine block and timing cover, the method comprising: providing a gasket; placing the gasket between an oil pan, an engine block and a timing cover; and sealing the gasket to the oil pan, the engine block and the time cover, wherein the gasket is molded to fit between the oil pan, the engine block and the timing cover, and wherein the gasket is removable.

In certain embodiments, the gasket includes load limiters that prevent over-tightening fasteners located on the oil pan. In certain embodiments, the load limiters are positioned within bores in the gasket.

In certain embodiments, the gasket includes at least one fastening member. In certain embodiments, the gasket includes at least one tightening member. In certain embodiments, the at least one fastening member and at least one tightening member are used to secure the gasket to the oil pan and engine block to seal the oil pan to the engine block.

In certain embodiments, the gasket may include a rigid core made of metal or plastic material to give flexural strength to the gasket.

In certain embodiments, the gasket mates against the engine block, timing cover, and oil pan sealing surfaces without the need to use liquid silicone rubber. In certain embodiments, the gasket is removable without great difficulty and may be reused. In certain embodiments, the gasket has surfaces that mate with the engine block, timing cover, and oil pan sealing surfaces.

In certain embodiments, the gasket saves time in servicing International T444E and Ford Powerstroke Diesel engines. The gasket allows the vehicle in which the engine is used to return to service more quickly, since the gasket is fully formed and no time is required for curing, as is the case when using a liquid silicone rubber material for sealing the gasket to the engine block.

Other objects of the invention are achieved by providing a kit for sealing an oil pan to an engine block, the kit comprising: a gasket, the gasket comprising a body having at least one bore extending therethrough and a rigid core; and at least one fastening member able to pass through the at least one bore in the gasket to secure the oil pan to the engine block.

In certain embodiments, the kit further includes at least one load limiter, the at least one load limiter being located within the at least one bore in the gasket.

In certain embodiments, the at least one fastening member is able to pass through the at least one load limiter in the gasket to secure the oil pan to the engine block.

Other objects of the invention are achieved by providing a kit for sealing an oil pan to an engine block, the kit comprising: a gasket, the gasket comprising: a body, the body having two longitudinal sections with at least one bore extending therethrough, and two connecting sections, the two connecting sections connecting the two longitudinal sections with one another; and a rigid core, the rigid core being located within at least one of the two connecting sections; and at least one fastening member, the at least one fastening member able to pass through the at least one bore in the gasket to secure the oil pan to the engine block.

In certain embodiments, the rigid core passes through each of the two connecting sections. In certain embodiments, the rigid core is located with the body and at least one of the two longitudinal sections. In certain embodiments, the rigid core is centrally located in a mold using supports in the mold that clamp the rigid core as the mold is closed. In certain embodiments, the rigid core of the body is made of metal and/or plastic. In certain embodiments, the rigid core is made of steel and/or a metal alloy.

In certain embodiments, the kit further comprises at least one tightening member, the at least one tightening member able to engage that at least one fastening member to secure the oil pan to the engine block.

In certain embodiments, the at least one fastening members is a bolts. In certain embodiments, the at least one tightening member is a nut. In certain embodiments, the kit includes 12 fastening members. In certain embodiments, each of the fastening members are 8 mm in length. In certain embodiments, the kit includes 12 tightening members, the 12 tightening members being Hex nuts of 8 mm length.

In certain embodiments, the gasket is one piece molded gasket. In certain embodiments, the gasket includes at least one load limiter that prevent over-tightening fasteners located on the oil pan. In certain embodiments, the at least one load limiter is positioned with the at least one bore in the body. In certain embodiments, the at least one fastening member passes through the at least one load limiter in the gasket to secure the oil pan to the engine block.

In certain embodiments, the gasket mates against the engine block and the oil pan, and seals surfaces without the need to use liquid silicone rubber. In certain embodiments, the gasket is sealed to the oil pan and the engine block without curing. In certain embodiments, the surfaces of the gasket mate against the sealing surfaces of the engine block and the oil pan.

In certain embodiments, to secure the oil pan to the engine block, the at least one fastening member is threaded into bores in the oil pan. In certain embodiments, the gasket is molded from silicone rubber.

Other objects of the invention are achieved by providing a one piece silicone rubber gasket using a steel core to eliminate the sole use of liquid silicone sealer for sealing an oil pan to an engine block.

In certain embodiments, the oil pan is an International T444E engine oil pan or a Ford Powerstroke oil pan.

In certain embodiments, the gasket is constructed out of high temperature/oil resistant material with rigid core and built-in steel inserts at each bolt hole.

Other objects of the invention are achieved by providing a gasket, the gasket comprising: a body, the body having two longitudinal sections with at least one bore extending therethrough, and two connecting sections, the two connecting sections connecting the two longitudinal sections with one another; and a rigid core, the rigid core being located within the body.

Other objects of the invention are achieved by having a one-piece gasket, the gasket comprising a body with at least one bore extending therethrough; and a rigid core, the rigid core being located within the body. In certain embodiments, the rigid core provides flexural strength to the gasket.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart of the various steps of the method of an embodiment of the invention;

FIG. 2 is a perspective view of a gasket of an embodiment of the invention;

FIG. 3 is a top view of the gasket of FIG. 2;

FIG. 4 is a side view of the gasket of FIG. 2;

FIG. 5 is a perspective view of the gasket of FIG. 2 fastened between an engine oil pan and an engine block;

FIG. 6 is a sectional view of the gasket of FIG. 2 showing a load limiter;

FIG. 7 is a perspective view of a section of a rigid core of the gasket of FIG. 2;

FIG. 8 is a side view of a section of the rigid core of the gasket of FIG. 2;

FIG. 9 is a top view a section of the rigid core of the gasket of FIG. 2;

FIG. 10 is a top view of the load limiter shown in FIG. 6;

FIG. 11 is a side view of the load limiter shown in FIG. 6;

FIG. 12 is a sectional view of the gasket of FIG. 3 along axis A;

FIG. 13 is a cross-sectional view of the gasket of FIG. 3 along axis B-B;

FIG. 14 is a cross-sectional view of the gasket of FIG. 3 along axis C-C; and

FIG. 15 is a cross sectional view of the gasket of FIG. 3 along axis D-D.

### DETAILED DESCRIPTION OF THE INVENTION

In the following description, numerous details are set forth for purpose of explanation. However, one of ordinary skill in the art will realize that the invention may be practiced without the use of these specific details. For instance, the techniques described below are described in a specified order, but other embodiments may change the order of the operations while still embodying the current invention.

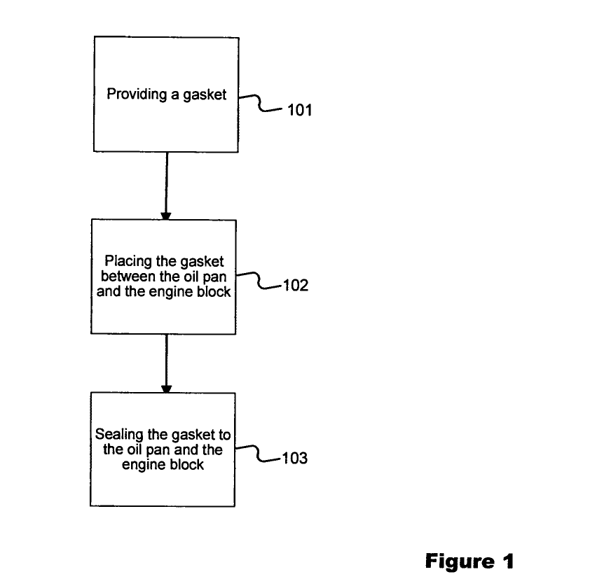

FIG. 1 shows various steps of the method of an embodiment of the invention. FIG. 1 shows the step of providing a gasket 101, placing the gasket between an oil pan and an engine block 102; and sealing the gasket to the oil pan and the engine block 103. The gasket is molded to fit between the oil pan and the engine block and the gasket is removable.

In certain embodiments, the gasket is sealed by using fastening devices and tightening devices. In certain embodiments, the fastening devices are threaded bolts and the tightening devices are nuts.

In certain embodiments, the gasket includes load limiters that prevent over-tightening fasteners located on the oil pan. In certain embodiments, the load limiters are located within bores in the gasket.

In certain embodiments, the gasket includes a rigid core, the rigid core made of metal and/or plastic. In certain embodiments, the gasket is reusable after it is removed. In certain embodiments, the gasket mates against the engine block and the oil pan, and seals surfaces without the need to use liquid silicone rubber. In certain embodiments, the gasket is sealed to the oil pan and the engine block without curing.

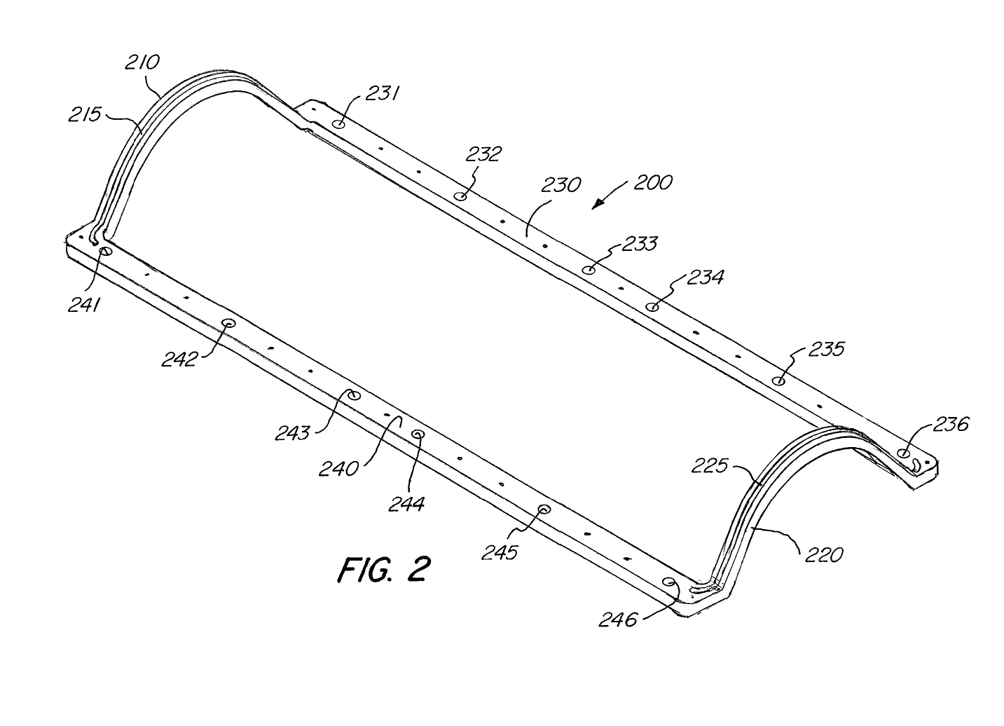

Referring to FIG. 2, a perspective view of a gasket 200 of an embodiment of the invention is shown. FIG. 2 shows gasket 200 having two body sections 230 and 240 connected to one another by two connecting sections 210 and 220. In certain embodiments, the two body sections 230 and 240 have a rectangular shape and extend longitudinally along the same plane. In certain embodiments, the two connecting sections 210 and 220 have an arc shape. In certain embodiments, the arc shape of the two connecting sections 210 and 220 allow the gasket to mate with an engine block.

In FIG. 2, body section 230 is shown having bores 231, 232, 233, 234, 235 and 236. Body section 240 is shown having bores 241, 242, 243, 244, 245 and 246. The number of bores are exemplary, as the invention may have either a greater or a fewer amount of bores extending through the body members.

FIG. 2 also shows connecting section 210 having a rigid core 215 and connecting section 220 having a rigid core 225. The rigid core is used to provide structural strength and integrity to the gasket 200.

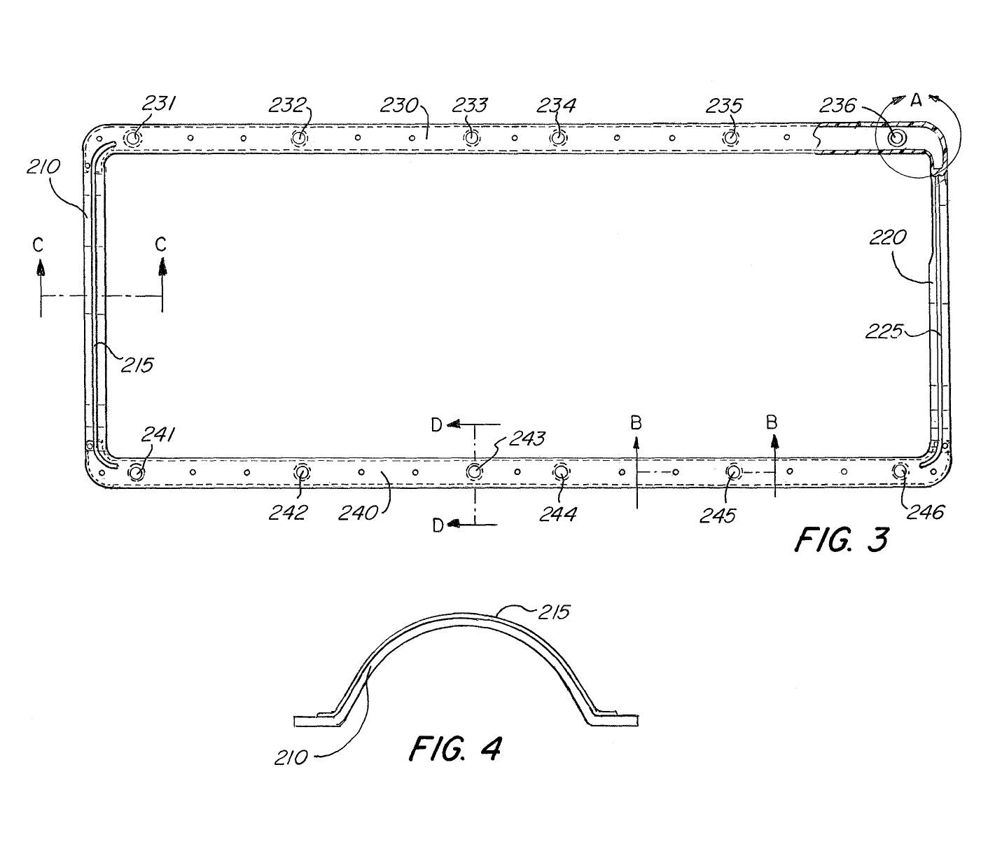

FIG. 3 shows a top view of gasket 200 of FIG. 2. In FIG. 3, body section 230 is shown having bores 231, 232, 233, 234, 235 and 236. Body section 240 is shown having bores 241, 242, 243, 244, 245 and 246.

FIG. 3 also shows connecting section 210 having a rigid core 215 and connecting section 220 having a rigid core 225. In certain embodiments, the rigid core is located within the connecting section. In other embodiments, the rigid core is either located above or below the connecting section. In certain embodiments, the rigid core is fused together with the connecting section, so that the rigid core and connection section are manufactured as one-piece.

FIG. 4 shows a side view of the gasket of FIG. 2 whereby the connecting section 210 is shown having a rigid core above the connecting section 210.

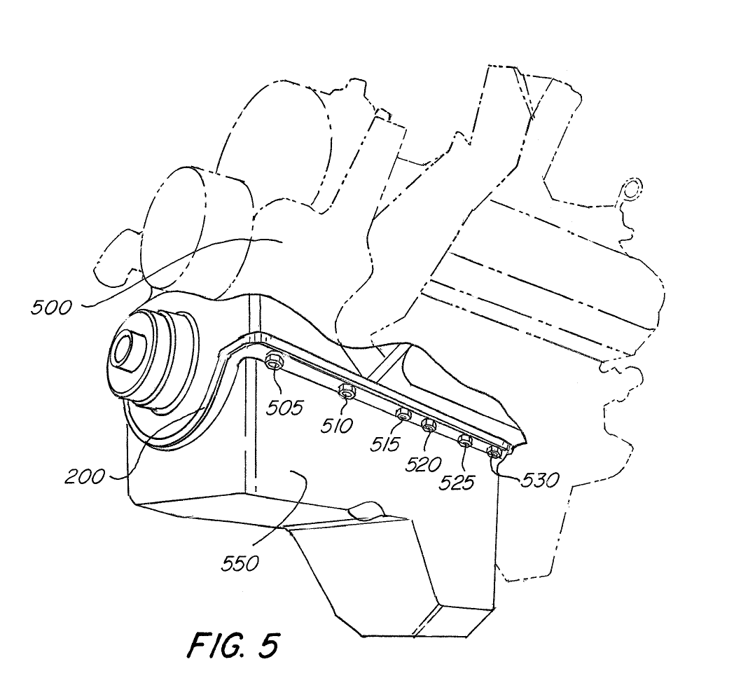

FIG. 5 is a perspective view of the gasket 200 of FIG. 2 fastened between an engine oil pan 550 and an engine block 500. In FIG. 5, fastening members 505, 510, 515, 520, 525, and 530 are shown. In certain embodiments, tightening members may be used to assist in tightening the fastening members, so that gasket 200 is secured between an engine oil pan 550 and an engine block 500.

In certain embodiments, each of the fastening members are 8 mm in length and are threaded bolts. In certain embodiments, the kit includes 12 tightening members, the 12 tightening members being Hex nuts of 8 mm length.

FIG. 6 shows a sectional view of the gasket of FIG. 2 showing a load limiter 610. The load limiter 610 is secured in a rigid core 740. The rigid core 740 may be present within the body of the gasket. The load limiter is shown having an internal body 620 and an external edge 630.

In FIGS. 7-9, views of a section of a rigid core 740 of the gasket 200 are shown. FIG. 7 is a perspective view, FIG. 8 is a side view and FIG. 9 is a top view of rigid core 740. Rigid core 740 is shown having bores 741, 742, 743, 744, 745 and 746 respectively. The bores in the rigid core are able to accept load limiter(s).

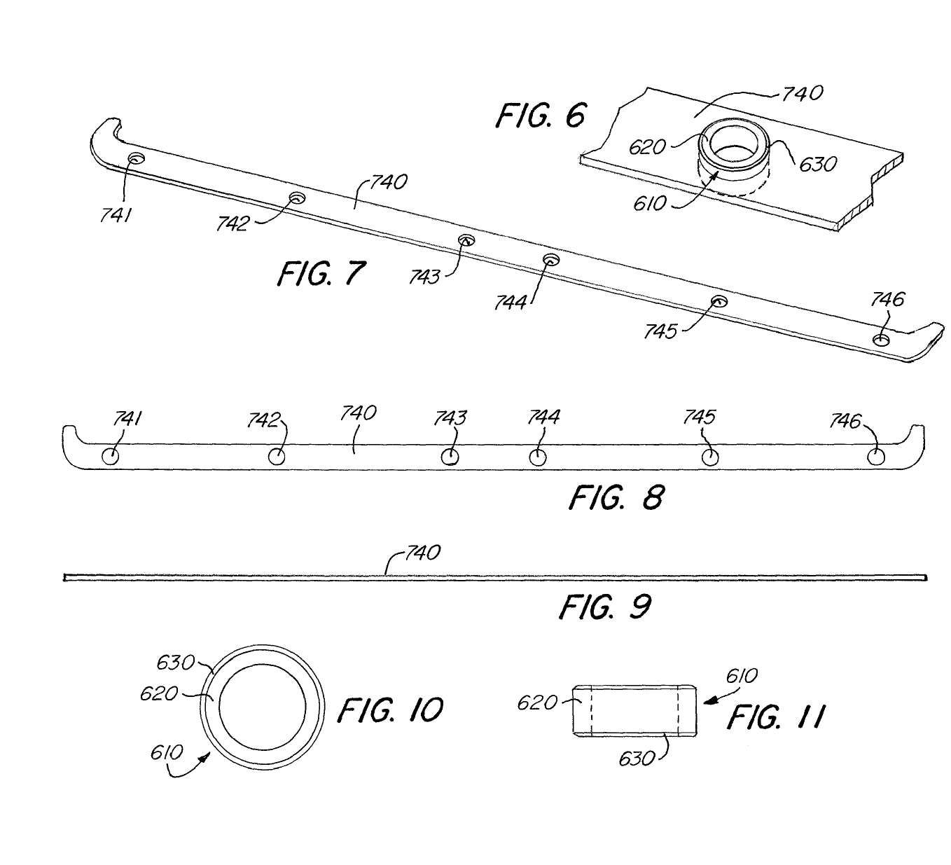

FIGS. 10-11 show a top view and a side view of the load limiter 610 of FIG. 6. The load limiter 610 has an internal body 620 and an external edge 630. Individual load limiter(s) 610 is able to fit within the bores 741, 742, 743, 744, 745 and 746, so that the rigid core is able to accept the load limiter(s) 610, thus, providing structural integrity to the gasket 200.

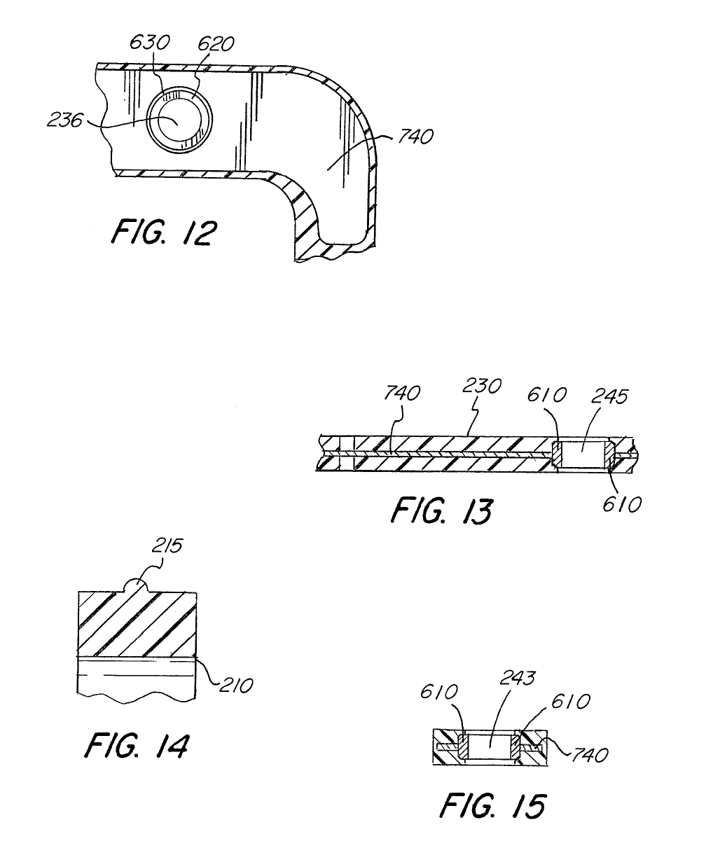

FIG. 12 shows a sectional view of the gasket of FIG. 3 along axis A. In FIG. 12, the load limiter 610 is shown being within bore 236 in body member 230. The rigid core 740 is shown being located with the body section 230.

FIG. 13 is a cross-sectional view of the gasket 200 of FIG. 3 along axis B-B. Here, the rigid core 740 is shown being within body section 230. Also shown is the load limiter 610 being within bore 245 in the body section 230. FIG. 14 is a cross-sectional view of the gasket 200 of FIG. 3 along axis C-C. Here the connecting section 210 is shown having a rigid core 215. FIG. 15 is a cross sectional view of the gasket 200 of FIG. 3 along axis D-D. Here, the rigid core 740 is shown being within body section 230. Also shown is the load limiter 610 being within bore 243 in the body section 230.

In certain embodiments, the rigid core is made of steel. In certain embodiments, the load limiters are made of steel or a metal alloy.

In certain embodiments, the gasket is provided as a kit with long studs to accommodate the thickness of the supplied gasket since the original design fasteners for the International T444E and the Ford Powerstroke Diesel engines were not intended for use with a gasket. In certain embodiments, the studs aid in the installation of the gasket when the engine is installed in the vehicle since the studs help hold the gasket in place while upside down. In certain embodiments, the studs also aid in the installation of the oil pan as the studs help position the oil pan while the installer starts the first few nuts onto each stud.

In certain embodiments, the studs are threaded and are threaded into the oil pan using mounting holes or mounting bores. In certain embodiments, a small amount of silicone sealant is provided to the gasket edge to assist is sealing. This small amount of sealant is not the main connection sealing the oil pan to the engine block.

In certain embodiments, the gasket is constructed out of high temperature/oil resistant material with a rigid core and built-in steel inserts at each bolt so that the gasket cannot be over tightened. In certain embodiments, the oil pan gasket cuts down time on oil pan installation for International T444E and the Ford Powerstroke Diesel engines.

In certain embodiments, a small bead of silicone sealant may be applied to an edge of the gasket. In this embodiment, the silicone acts to help seal the oil pan to the engine block, however, the silicone sealant is not the primary agent for sealing and simply acts as a secondary source of sealing.

In certain embodiments, the method involves applying an approximately 1 inch long bead of silicone sealant to the gasket. In certain embodiments, the approximately 1 inch long bead of silicone sealant is applied to an edge of the gasket.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A method for sealing an oil pan to an engine block, the method comprising:
providing a gasket;
placing the gasket between an oil pan and an engine block; and
sealing the gasket to the oil pan and the engine block,
wherein the gasket is molded to fit between the oil pan and the engine block, and
wherein the gasket is removable.

2. The method of claim 1, wherein the oil pan is an International T444E engine oil pan or a Ford Powerstroke oil pan.

3. The method of claim 1, wherein the gasket is one piece molded gasket.

4. The method of claim 1, wherein the gasket includes multiple parts.

5. The method of claim 1, wherein the gasket includes load limiters that prevent over-tightening fasteners located on the oil pan.

6. The method of claim 1, wherein the gasket includes a rigid core, the rigid core made of metal and/or plastic.

7. The method of claim 1, wherein the gasket is reusable after it is removed.

8. The method of claim 1, wherein the gasket mates against the engine block and the oil pan, and seals surfaces without the need to use liquid silicone rubber.

9. The method of claim 1, wherein the gasket is sealed to the oil pan and the engine block without curing.

10. A kit for sealing an oil pan to an engine block, the kit comprising:
a gasket, the gasket comprising a body having at least one bore extending therethrough and a rigid core; and
at least one fastening member able to pass through the at least one bore in the gasket to secure the oil pan to the engine block.

11. The kit of claim 10, further comprising at least one load limiter, the at least one load limiter being located within the at least one bore in the gasket, wherein the at least one the at least one fastening member is able to pass through the at least one load limiter in the gasket to secure the oil pan to the engine block.

12. A kit for sealing an oil pan to an engine block, the kit comprising:
a gasket, the gasket comprising:
a body, the body having two longitudinal sections with at least one bore extending therethrough, and two connecting sections, the two connecting sections connecting the two longitudinal sections with one another; and
a rigid core, the rigid core being located within at least one of the two connecting sections; and
at least one fastening member, the at least one fastening member able to pass through the at least one bore in the gasket to secure the oil pan to the engine block.

13. The kit of claim 12, further comprising at least one nut, the at least one nut able to engage that at least one fastening member to secure the oil pan to the engine block.

14. The kit of claim 12, wherein the rigid core of the body is made of metal and/or plastic.

15. The kit of claim 12, wherein the gasket is one piece molded gasket.

16. The kit of claim 12, wherein the gasket includes load limiters that prevent over-tightening fasteners located on the oil pan.

17. The kit of claim 12, wherein the gasket mates against the engine block and the oil pan, and seals surfaces without the need to use liquid silicone rubber.

18. The kit of claim 12, wherein the gasket is sealed to the oil pan and the engine block without curing.

19. The kit of claim 12, wherein to secure the oil pan to the engine block, the at least one fastening member is threaded into bores in the oil pan.

20. The kit of claim 12, wherein the gasket is molded from silicone rubber.
